(19) United States
(12) Patent Application Publication
(10) Pub. No.: US 2015/0339330 A1
(43) Pub. Date: Nov. 26, 2015

(54) SYSTEM AND METHOD FOR CONTENT DEPLOYMENT

(71) Applicants: SONY CORPORATION, Tokyo (JP); SONY NETWORK ENTERTAINMENT INTERNATIONAL LLC, Los Angeles, CA (US)

(72) Inventor: MILES ZARN, San Jose, CA (US)

(73) Assignees: SONY CORPORATION, Tokyo (JP); SONY NETWORK ENTERTAINMENT INTERNATIONAL LLC, Los Angeles, CA (US)

(21) Appl. No.: 14/282,552

(22) Filed: May 20, 2014

(51) Int. Cl. G06F 17/30

(52) U.S. Cl. CPC G06F 17/30309; G06F 17/30861

(57) ABSTRACT

Various aspects of a system and method for content deployment may include a server communicatively coupled to one or more client devices. The server may be associated with a web-based store. The server may be operable to receive information from a client device to request access to the web-based store. The server may be further operable to determine whether the client device is to be assigned to one of a plurality of channels of content access based on the received information. Each of the plurality of channels may be associated with a pre-specified version of content. The server may be further operable to randomly assign the client device to one of the plurality of channels based on the determination that the one or more client devices satisfy a set of parameters.

### FIELD

Various embodiments of the disclosure relate to content deployment. More specifically, various embodiments of the disclosure relate to a system and method for content deployment.

### BACKGROUND

Web-based stores in electronic commerce enable users to browse catalogs of products and services, make purchases, and create profiles for faster checkouts. The products and services available on these web-based stores include content, such as video, music, game content, applications, and the like. The providers of the content often release different versions of the content with updates and/or improvements over existing versions of the content.

Often, providers experiment with the content by publishing, measuring and statistically comparing the different versions of the content, before exposing the entire customer base to a particular version of the content. This enables the providers to quickly learn user behaviors with different versions and allows a quick rate of product innovation, based on customer feedback data. However, existing systems for content deployment are capable of serving only a single version of the content to the entire customer base at one time. This poses a risk of exposing the entire customer base to ineffective or revenue-impacting versions of the content. On the other hand, when web-based stores grow in customer number, there is a need to migrate user traffic from one release of content to another, in a controlled manner.

Further limitations and disadvantages of conventional and traditional approaches will become apparent to one of skill in the art, through comparison of described systems with some aspects of the present disclosure as set forth in the remainder of the present application, with reference to the drawings.

### SUMMARY

A system and method are provided for content deployment substantially as shown in, and described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram illustrating a network environment for content deployment, in accordance with an embodiment of the disclosure.

FIG. 2 is a block diagram illustrating a computing device for content deployment, in accordance with an embodiment of the disclosure.

FIG. 3 is a flow chart illustrating exemplary steps for content deployment, in accordance with an embodiment of the disclosure.

FIG. 4 is a diagram illustrating an assignment sequence for content deployment, in accordance with an embodiment of the disclosure.

### DETAILED DESCRIPTION

Various implementations may be found in a system and method for content deployment. Exemplary aspects of a method for content deployment may include a server having one or more processors communicatively coupled to one or more client devices. In an embodiment, the server may be operable to generate one or more versions of a metadata file that correspond to each of a plurality of channels for accessing content. Each of the plurality of channels may be associated with a pre-specified version of the content. The server may be further operable to store the one or more versions of the metadata file to be randomly assigned to the client devices based on a set of parameters.

In an embodiment, the server may be operable to send one of the versions of the metadata file to a requesting client device, based on the determination that the one or more requesting client devices satisfy the set of parameters. The set of parameters may comprise one or more of a pre-specified geography associated with the client devices or a pre-specified device type of the client devices.

Exemplary aspects of the disclosed method for content deployment may include a server having one or more processors communicatively coupled to a client device. The server may be associated with a web-based store. In an embodiment, the server may be operable to receive information from the client device that requests access to the web-based store. The server may be further operable to determine whether the client device is to be assigned to one of a plurality of channels of content access based on the received information. Each of the plurality of channels may be associated with a pre-specified version of content. The server may be further operable to randomly assign the client device to one of the plurality of channels, based on determining that the client device satisfies a set of parameters.

In an embodiment, the server may be operable to assign the client device to one of the plurality of channels via a hashing algorithm applied to an identifier included in the received information. In an embodiment, the information may be contained in a metadata file received from the client device. The metadata file may indicate a version of cached copy of files stored on the client device.

In an embodiment, the server may be operable to send one of a plurality of versions of the metadata file to the randomly assigned client device. Each of the versions of the metadata file corresponds to one of the plurality of channels. The server may be operable to provide access to the pre-specified version of the content to the randomly assigned client device. In an embodiment, the set of parameters may comprise one or more of a pre-specified geography associated with the client device or a pre-specified device type of the client device.

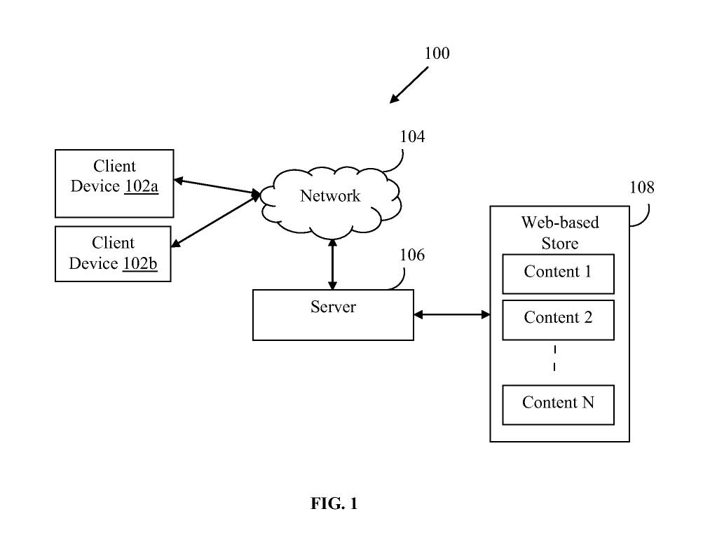

FIG. 1 is a block diagram illustrating a network environment for content deployment, in accordance with an embodiment of the disclosure. In reference to FIG. 1, there is shown a network environment 100. The network environment 100 may comprise client devices 102a and/or 102b, a communication network 104, a server 106, and a web-based store 108.

The client devices 102a and/or 102b may be one or more of a mobile device, a cellular phone, a tablet, a laptop computer, a personal computer, and consumer devices or appliances, such as a network-enabled game console or a network-enabled smart television. The client devices 102a and/or 102b may include other computing devices capable of connecting to a web application configured in hypertext markup language (HTML), cascading style sheets (CSS), JavaScript, and the like. The client devices 102a and/or 102b may be capable of browsing through the web application to receive and store cache files and/or manifest files from the web application. The client devices 102a and/or 102b may comprise suitable logic, circuitry, interfaces, and/or code that may enable communication with the server 106, and/or the web-based store 108. The interfaces of the client devices 102a and/or 102b may comprise one or more network interfaces that may enable communication with the server 106.

The communication network 104 may include a medium through which the server 106 may communicate with the client devices 102a and/or 102b, in the network environment 100. Examples of the communication network 104 may include, but are not limited to, the Internet, a Wireless Fidelity (WiFi) network, a Wireless Local Area Network (WLAN), a Local Area Network (LAN), a telephone line (POTS), and/or a Metropolitan Area Network (MAN). Various devices in the network environment 100 may be operable to connect to the communication network 104, in accordance with various wired and wireless communication protocols, such as Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, and/or Bluetooth (BT) communication protocols.

The server 106 may comprise suitable logic, circuitry, interfaces, and/or code that may enable communication with the client devices 102a and/or 102b, and the web-based store 108, either directly or via the communication network 104. In an embodiment, the server 106 may be implemented as part of a server cloud. The server 106 may be accessed and managed by one or more administrators or content providers. The administrators may set up channels of content access, create and/or update manifest files, and/or define filters to assign or direct the client devices 102a and/or 102b to different versions of content based on the manifest files. For example, each channel of content access may refer to a universal resource identifier (URI) that directs the client devices 102a and/or 102b to different versions of content on the web-based store 108. In an embodiment, an administrator may interact with the server 106 directly. In an embodiment, the administrator user may issue commands or instructions indirectly to the server 106 via the communication network 104.

The web-based store 108 may comprise suitable logic, circuitry, interfaces, and/or code that may enable communication with the server 106. The web-based store 108 may be accessed and managed by one or more administrators or content providers. The one or more administrators or content providers may upload, store, manage and/or deliver web-based content, applications and resources to the client devices 102a and/or 102b via the communication network 104. The web-based store 108 may be JavaScript (JS) enabled. The web-based store 108 may be operable to serve content, such as JS-based content, hypertext markup language (HTML) content, extensible HTML (XHTML) content, media files, software, games, documents, and/or the like. The web-based store 108 may be operable to serve applications, such as e-commerce portals, social networks, and/or the like. The content, applications, and other resources capable of being served by the web-based store 108, are collectively referred to herein as “content”. In an embodiment, the web-based store 108 may be a game store offering a range of downloadable content, such as games, demos, themes, trailers, and/or the like. In an embodiment, the web-based store 108 may be operable to store different versions of the content or applications, with or without variations among the versions of the content. In an embodiment, the web-based store 108 may be part of a content distribution network (CDN) spread across the Internet.

In operation, the server 106 may be operable to generate one or more versions of a metadata file that corresponds to each of a plurality of channels to access content. Each of the plurality of channels may be associated with a pre-specified version of the content. The server 106 may be further operable to store one or more versions of the metadata file to be randomly assigned to the client devices 102a and/or 102b, based on a set of parameters. In an embodiment, the metadata file is a JS manifest file.

In an embodiment, the server 106 may be associated with a web-based store 108. The server 106 may be communicatively coupled to a client device 102a and/or 102b. The server 106 may be operable to receive information from the client devices 102a and/or 102b, which may request access to the web-based store 108. The server 106 may be further operable to determine whether the client devices 102a and/or 102b are to be assigned to one of a plurality of channels of content access based on the received information. Each of the plurality of channels may be associated with a pre-specified version of content. The server 106 may be further operable to randomly assign the client devices 102a and/or 102b to one of the plurality of channels, based on the determination that the client devices 102a and/or 102b satisfy a set of parameters.

In an embodiment, the pre-specified version of content may include a version of content available on the web-based store 108. For example, the pre-specified version of content may include a version of JS-based HTML content that may be rendered on the client devices 102a and/or 102b, and with which the user of the client devices 102a and/or 102b interact. In another example, the pre-specified version of content includes a version of downloadable content available on the web-based store 108.

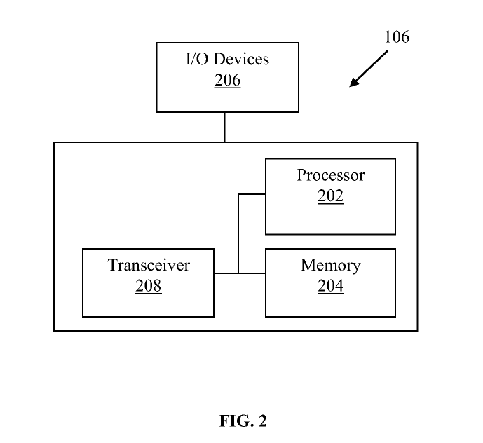

FIG. 2 is a block diagram illustrating a computing device for content deployment, in accordance with an embodiment of the disclosure. FIG. 2 is explained in conjunction with elements from FIG. 1. With reference to FIG. 2, there is shown a server 106, which may comprise a processor 202, a memory 204, Input-Output (I/O) devices 206, and a transceiver 208.

The processor 202 may be communicatively coupled to the memory 204, and the I/O devices 206. Further, the transceiver 208 may be communicatively coupled to the processor 202, the memory 204, and the I/O devices 206.

The processor 202 may comprise suitable logic, circuitry, interfaces, and/or code that may be operable to execute a set of instructions stored in the memory 204. The processor 202 may be implemented based on a number of processor technologies known in the art. Examples of processor 202 may be an X86-based processor, a RISC processor, an ASIC processor, a CISC processor, or any other processor.

The memory 204 may comprise suitable logic, circuitry, interfaces, and/or code that may be operable to store the received set of instructions. The memory 204 may be implemented based on, but not limited to, a Random Access Memory (RAM), a Read-Only Memory (ROM), a Hard Disk Drive (HDD), a storage server and/or a secure digital (SD) card. The memory 204 may be operable to store one or more versions of a manifest file and experiment identifiers (IDs) that are to be stored in the versions of the manifest file. The experiment IDs are associated with versions of content that are designated for experimentation, such as the NB experimentation known in the art.

The I/O devices 206 may comprise various input and output devices operably connected to the processor 202. Examples of input devices include, but are not limited to, a keyboard, a mouse, a joystick, a touch screen, a microphone, a camera, a motion sensor, a light sensor, and/or a docking station. Examples of output devices include, but are not limited to, a display, and/or a speaker.

The transceiver 208 may comprise suitable logic, circuitry, interfaces, and/or code that may be operable to communicate with the client devices 102a and/or 102b, via different communication interfaces. The transceiver 208 may implement known technologies to support wired or wireless communication with the communication network 104. The transceiver 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer. The transceiver 208 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

In operation, the processor 202 may be operable to generate one or more versions of a metadata file that corresponds to each of a plurality of channels for accessing content. Each of the plurality of channels may be associated with a pre-specified version of the content. The processor 202 may be further operable to store the one or more versions of the metadata file to be randomly assigned to the client devices 102a and/or 102b, based on a set of parameters. In an embodiment, the metadata file is a JS manifest file.

In an embodiment, the processor 202 may be operable to send one of the versions of the metadata file to client devices 102a and/or 102b when requested. The metadata file may be sent based on the determination that the client devices 102a or 102b satisfy a set of parameters. The set of parameters may comprise one or more of a pre-specified geography associated with the client devices 102a and/or 102b, or a pre-specified device type of the client devices 102a and/or 102b.

In an embodiment, the processor 202 may be operable to receive information from client devices 102a and/or 102b, which may request access to the web-based store 108. The processor 202 may be further operable to determine whether the client devices 102a and/or 102b are to be assigned to one of a plurality of channels of content access, based on the received information. Each of the plurality of channels may be associated with a pre-specified version of content. The processor 202 may be further operable to randomly assign the client devices 102a and/or 102b to one of the plurality of channels, based on the determination that the client devices 102a and/or 102b satisfy a set of parameters.

In an embodiment, the processor 202 may be operable to apply a hashing algorithm to an ID included in the received information to randomly assign the client devices 102a and/or 102b to one of the channels. In an embodiment, the information may be contained in a metadata file received from the client devices 102a and/or 102b. The metadata file may indicate a version of cached copy of files stored on the client devices 102a and/or 102b.

In an embodiment, the processor 202 may be operable to send one of a plurality of versions of the metadata file to the randomly assigned client devices 102a and/or 102b. Each of the versions of the metadata file corresponds to one of the plurality of channels. The processor 202 may be operable to provide access to the pre-specified version of the content to the randomly assigned client devices 102a and/or 102b.

In an embodiment, the set of parameters may comprise one or more of a pre-specified geography associated with the client devices 102a and/or 102b, or a pre-specified device type of the client devices 102a and/or 102b. In an embodiment, the set of parameters may comprise one or more of an internet protocol (IP) address of the client devices 102a and/or 102b, or a customer ID associated with the client devices 102a and/or 102b.

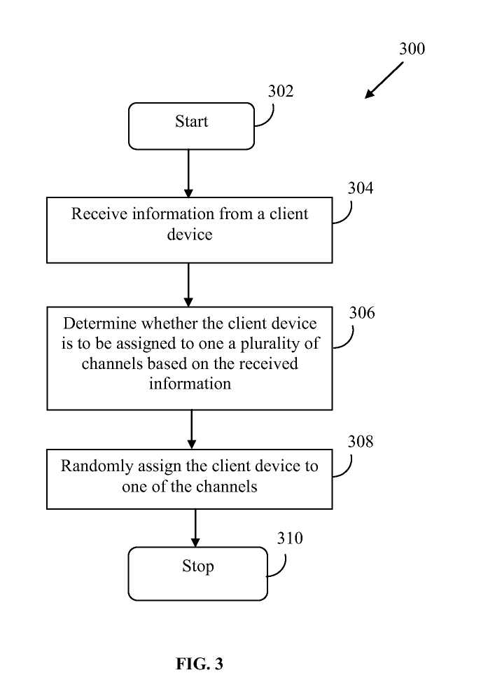

FIG. 3 is a flow chart illustrating exemplary steps for content deployment, in accordance with an embodiment of the disclosure. FIG. 3 is explained in conjunction with elements from FIG. 1 and FIG. 2. The method 300 may be implemented in the server 106, communicatively coupled to the client devices 102a and/or 102b.

The method 300 begins at step 302 and proceeds to step 304. At step 304, information from the client devices 102a and/or 102b, may be received to request access to the web-based store 108. The method proceeds to step 306.

At step 306, based on the received information, it may be determined that the client devices 102a and/or 102b are to be assigned to one of a plurality of channels of content access. In an embodiment, each of the plurality of channels may be associated with a pre-specified version of content. In an embodiment, a hashing algorithm may be applied to an ID included in the received information. The hashing algorithm may randomly assign the client devices 102a and/or 102b to one of the channels. In an embodiment, the information may be contained in a metadata file received from the client devices 102a and/or 102b. The method proceeds to end step 308.

At end step 308, the client devices 102a and/or 102b may be randomly assigned to one of the channels based on the determination that the client devices 102a and/or 102b satisfy a set of parameters. In an embodiment, one of the versions of the metadata file may be sent to the randomly assigned client devices 102a and/or 102b. The randomly assigned client devices 102a and/or 102b may be provided access to the pre-specified version of the content.

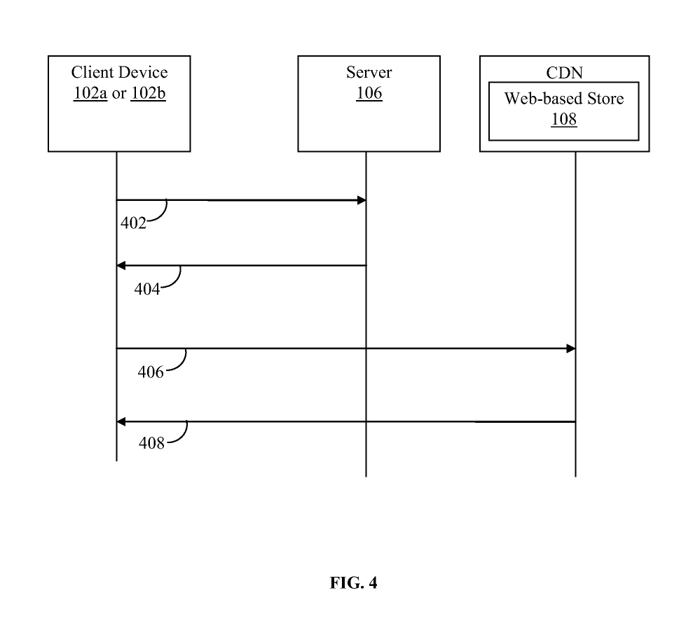

FIG. 4 is a diagram illustrating an assignment sequence for content deployment, in accordance with an embodiment of the disclosure. FIG. 4 is being described in conjunction with elements from FIG. 1 and FIG. 2.

At step 402, the client device 102a may request access to the web-based store 108, using a web store ID. The request may or may not contain an identifier, such as a device ID/ client ID or any other unique identifier. In an embodiment, the client device 102a may post the client ID and request a specific version of content. In an embodiment, the client device 102a may request a manifest file from the server 106.

At step 404, based on the device ID, the server 106 randomly assigns the client device 102a to one of the channels of content access that has been designated for experimentation. In an embodiment, the server 106 may send one or more of: a Hypertext Transfer Protocol (HTTP) response code (headers only), HTTP content (any type), a binary blob, true or false values, a text file, or any combination thereof, to the client device 102a. In an embodiment, the server 106 may send a version of the manifest file that corresponds to the channel designated for experimentation to the client device 102a. The server 106 may also send experiment IDs that correspond to an experiment to the client device 102a. In an embodiment, the server 106 may set a cookie or a persistent unique identifier on the client device 102a.

At step 406, based on the response from the server 106, the client device 102a may (i) request a different client version, (ii) change content distribution network (CDN) requests, (iii) change client behavior, or (iv) request a service or content from another server external to the CDN. In an embodiment, the client device 102a may send JS files to the web-based store 108, which is part of or associated with the CDN. In an embodiment, based on the response from the server, the client device 102a may change the version of the client JavaScript requested.

At step 408, the web-based store 108 may respond to the client device 102a with a different version of the JS client files. In an embodiment, the response from the web-based store 108 may contain multiple types of JS client files. The client device 102a may in turn originate requests based on programming instructions. In an embodiment, the response from the web-based store 108 may contain a single version of the JS client file for which the server response at step 404 acts as a functionality switch in the current version of the JS client file.

In an embodiment, the server 106 may request a JS client manifest file from the client devices 102a and/or 102b to determine whether the client devices 102a and/or 102b store a current version of JS cached files. The JS client manifest file may define the version of the JS cached files stored on the client devices 102a and/or 102b. When an update to the content on the web-based store 108 occurs, the server 106 may switch the version of the JS client manifest file stored on the client devices 102a and/or 102b to another version. The client devices 102a and/or 102b may download the version of JS cached files that is defined by the switched version of the JS manifest file. Based on the version of the JS client manifest file stored on the client devices 102a and/or 102b, the user interaction and the client side calls may be controlled to enable experimentation on a per-client basis.

In an embodiment, the requested JS client manifest may provide a globally unique identifier (GUID) and an origin internet protocol (IP) address associated with the client devices 102a and/or 102b. In an embodiment, the server 106 may use a hash of the GUID to determine the assignment of the client devices 102a and/or 102b to one of the channels. In an embodiment, the country of origin of the client devices 102a and/or 102b may be determined using a geographic IP address service.

In an embodiment, the server 106 may register one or more versions of the JS manifest file for each experiment version of the content to create a unique experiment ID. The JS manifest file may be an encrypted file containing a list of uniform resource identifiers (URIs) that may be configured to direct the client devices 102a and/or 102b to a specific version of the content. The registered JS manifest file may be enabled for a list of specified geographic locations, a percentage of incoming traffic, or both. The server 106 may be configured to set traffic percentages for experimentation on a per-country basis, or set the same traffic percentage for all geographies. When an experiment is enabled, the traffic assignment may be achieved by randomly setting a percentage of channels to the experiment version of the content. The client devices 102a or 102b assigned to the channels set for the experiment version may be exposed to the experiment. The remaining channels and/or traffic may be assigned to a default version of the content.

In an embodiment, the experiments may be processed in chronological order. The server 106 may determine whether an experiment is active for the current period of time. The server may determine whether the country of origin of the client devices 102a and/or 102b are eligible for the experiment. If the country of origin is eligible for the experiment, the server 106 may determine if the experiment version is the default version for the country of origin. If no other experiments are enabled for that country of origin, a default manifest file that corresponds to the default version is sent to the client devices 102a and/or 102b. If the country of origin is eligible for the experiment, the server 106 may determine whether the experiment is randomly assigned to a group of device IDs. If the experiment is assigned to the group of device IDs, the server 106 may send the manifest file that corresponds to the experiment version to the client devices 102a and/or 102b.

In an embodiment, the feedback for the experiments may be collected based on events posted to the server 106. In an embodiment, the client device 102a may generate events, and communicate the events to the server 106 for event aggregation and interpretation. In another embodiment, the client device 102a may generate and aggregate events, and then communicate the results of aggregation to the server 106. In an embodiment, the events are posted to the server 106 via HTTP post operation. Each event posted may include the experiment ID that corresponds to the experiment version that led to the event. The server 106 may determine whether an event has occurred from the experiment version or the default version. The events may be collated and processed to generate metrics and statistically compare the different versions of the content.

In an embodiment, A/B experimentation may occur where a small group of customers are randomly exposed to or explicitly assigned to an experiment version of content on the web-based store 108. The small group of customers may represent, or is intended to represent, the entire customer base. In an embodiment, phased deployment for the web-based store 108 may occur in order to migrate customer traffic from one release to another, in a controlled manner. In an embodiment, the live site version management, server load management, and data center sharing applications may be employed.

In accordance with the present disclosure, a system for content deployment may comprise a server 106 communicatively coupled to client devices 102a and/or 102b. The server 106 may comprise one or more processors, for example, processor 202 (FIG. 2). The processor 202 may be operable to generate one or more versions of a metadata file that corresponds to each of a plurality of channels for accessing content. Each of the plurality of channels may be associated with a pre-specified version of the content. The processor 202 may be further operable to store the one or more versions of the metadata file to be randomly assigned to the client devices 102a and/or 102b, based on a set of parameters.

In accordance with the present disclosure, a system for content deployment may comprise a server 106 communicatively coupled to client devices 102a and/or 102b, and a web-based store 108. The server 106 may comprise one or more processors, for example, processor 202 (FIG. 2). The processor 202 may be operable to receive information from client devices 102a and/or 102b, to request access to the web-based store 108. The processor 202 may be further operable to determine whether the client devices 102a and/or 102b are to be assigned to one of a plurality of channels of content access, based on the received information. Each of the plurality of channels may be associated with a pre-specified version of content. The processor 202 may be further operable to randomly assign the client devices 102a and/or 102b, to one of the plurality of channels based on the determination that the client devices 102a and/or 102b satisfy a set of parameters.

Various embodiments of the disclosure may provide a non-transitory computer readable medium and/or storage medium, and/or a non-transitory machine readable medium and/or storage medium. Having applicable mediums stored thereon, a machine code and/or a computer program having at least one code section executable by a machine and/or a computer for content deployment. The at least one code section in a server 106 may cause the machine and/or computer to perform the steps comprising receiving information from a client devices 102a and/or 102b, to request access to the web-based store 108. Based on the received information, it may be determined whether the client devices 102a and/or 102b are to be assigned to one of a plurality of channels of content access. In an embodiment, each of the plurality of channels may be associated with a pre-specified version of content. The client devices 102a and/or 102b may be randomly assigned to one of the channels based on the determination that the client devices 102a and/or 102b satisfy a set of parameters.

Accordingly, the present disclosure may be realized in hardware, or a combination of hardware and software. The present disclosure may be realized in a centralized fashion in at least one computer system or in a distributed fashion where different elements may be spread across several interconnected computer systems. Any kind of computer system or other apparatus adapted for carrying out the methods described herein may be suited. A combination of hardware and software may be a general-purpose computer system with a computer program that, when being loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A system for content deployment, comprising:
in a server communicatively coupled to one or more client devices, one or more processors in said server operable to:
generate one or more versions of a metadata file corresponding to each of a plurality of channels for accessing content, wherein each of said plurality of channels is associated with a pre-specified version of said content; and
store said one or more versions of said metadata file to be randomly assigned to said one or more client devices based on a set of parameters.

2. The system of claim 1, wherein said one or more processors are operable to communicate one of said one or more stored versions of said metadata file to a requesting client device based on determining whether said requesting client device satisfies said set of parameters.

3. The system of claim 1, wherein said set of parameters comprises one or more of: a pre-specified geography associated with said one or more client devices or a pre-specified device type of said one or more client devices.

4. A system for content deployment, comprising:
in a server associated with a web-based store, one or more processors in said server operable to:
receive information from a client device requesting access to said web-based store;
determine whether said client device is to be assigned to one of a plurality of channels for accessing content based on said received information, wherein each of said plurality of channels is associated with a pre-specified version of content; and
randomly assign said client device to one of said plurality of channels based on determining whether said client device satisfies a set of parameters.

5. The system of claim 4, wherein said one or more processors are operable to apply a hashing algorithm to an identifier included in said received information to randomly assign said client device to one of said plurality of channels.

6. The system of claim 4, wherein said information is contained in a metadata file received from said client device.

7. The system of claim 6, wherein said metadata file indicates a version of a cached copy of files stored on said client device.

8. The system of claim 4, wherein said one or more processors are operable to send one of a plurality of versions of a metadata file to said randomly assigned client device, wherein each of said plurality of versions of said metadata file corresponds to one of said plurality of channels.

9. The system of claim 4, wherein said set of parameters comprises one or more of: a pre-specified geography associated with said one or more client devices or a pre-specified device type of said one or more client devices.

10. The system of claim 4, wherein said one or more processors are operable to provide access to said pre-specified version of said content to said randomly assigned client device.

11. A method for content deployment, comprising:
in a server communicatively coupled to one or more client devices:
generating one or more versions of a metadata file corresponding to each of a plurality of channels for accessing content, wherein each of said plurality of channels is associated with a pre-specified version of said content; and
storing said one or more versions of said metadata file to be randomly assigned to said one or more client devices based on a set of parameters.

12. The method of claim 11, further comprising communicating one of said one or more stored versions of said metadata file to a requesting client device based on determining whether said requesting client device satisfies said set of parameters.

13. The method of claim 11, wherein said set of parameters comprises one or more of: a pre-specified geography associated with said one or more client devices or a pre-specified device type of said one or more client devices.

14. A method for content deployment, comprising:
in a server associated with a web-based store:
receiving information from a client device requesting access to said web-based store;
determining whether said client device is to be assigned to one of a plurality of channels for accessing content based on said received information, wherein each of said plurality of channels is associated with a pre-specified version of content; and
randomly assigning said client device to one of said plurality of channels based on determining whether said client device satisfies a set of parameters.

15. The method of claim 14, further comprising applying a hashing algorithm to an identifier included in said received information to determine said assignment of said client device to one of said plurality of channels.

16. The method of claim 14, wherein said information is contained in a metadata file received from said client device.

17. The method of claim 16, wherein said metadata file indicates a version of a cached copy of files stored on said client device.

18. The method of claim 14, further comprising sending one of a plurality of versions of a metadata file to said randomly assigned client device, wherein each of said plurality of versions of said metadata file corresponds to one of said plurality of channels.

19. The method of claim 14, wherein said set of parameters comprises one or more of:
a pre-specified geography associated with said client device or a pre-specified device type of said client device.

20. The method of claim 14, comprising providing access to said pre-specified version of said content to said randomly assigned client device.
